(19) United States
(12) Patent Application Publication
(10) Pub. No.: US 2005/0127647 A1
(43) Pub. Date: Jun. 16, 2005

(54) Side curtain airbag system

(76) Inventor: Min Woo Jo, Seoul (KR)

Correspondence Address: MORGAN, LEWIS & BOCKIUS LLP (SF), 2 PALO ALTO SQUARE, PALO ALTO, CA, 94306, US

(21) Appl. No.: 11/010,013

(22) Filed: Dec. 10, 2004

(30) Foreign Application Priority Data
Dec. 10, 2003 (KR) 2003-0089528

(51) Int. Cl. B60R 21/22

(52) U.S. Cl. 280/730.2

(57) ABSTRACT

A side curtain airbag of a vehicle comprising a gas pipe formed with a plurality of gas injection films that are detached or ruptured by gas generated from the deployment of an inflator is disclosed. The gas pipe is initially filled with gas having a predetermined pressure. When the inflator deploys and a high pressure gas is injected into the gas pipe, the high pressure gas causes the plurality of gas injection films to detach from the gas pipe or rupture. The gas is supplied to all sections of the curtain airbag, thus inflating the curtain airbag evenly. The deployment time of the curtain airbag is also reduced.

### CROSS-REFERENCE TO RELATED APPLICATIONS

The present application is based on, and claims priority from, Korean Application Number 10-2003-0089528, filed on Dec. 10, 2003, the disclosure of which is hereby incorporated by reference herein in its entirety.

### FIELD OF THE INVENTION

The present invention relates to a side curtain airbag system. More particularly, the present invention relates to a rapidly and evenly deploying side curtain airbag in the event of a vehicular crash.

### BACKGROUND OF THE INVENTION

Generally, vehicles are equipped with various safety devices to protect occupants in vehicle collisions. As one of the safety devices for a vehicle, an air bag protects against injury to a passenger's chest and head region, whether the passenger is a child or adult, in a head-on or side collision.

Typically, the driver's air bag is stored in the middle of a steering wheel while the air bag for a front passenger is stored inside a crash pad. In order to optimize protection to a passenger, an additional air bag is installed beside within the left or right side of seats, or along a roof side rail, thereby protecting the passengers even against impact in a side collision.

The air bag arranged along the roof side rail is called the side curtain airbag. The side curtain airbag system provides gas generated from an inflator to an air bag via a gas pipe. When the air bag inflates from the roof side rail into the passenger compartment completely, the curtain airbag covers the side window.

There is a drawback in the conventional curtain airbag in that it is configured so that gas flows into the curtain airbag from the rear pillar, which is near the inflator, to the middle pillar, and then to the front pillar. This configuration causes a deployment time difference for the curtain airbag between the rear pillar and front pillar.

In order to safely protect the passengers from a side collision impact, the pillars for the side curtain airbag should be inflated at the same time. The deployment time of the side curtain airbags should also be decreased.

### SUMMARY OF THE INVENTION

The present invention is adapted to simultaneously deploy all positions of the curtain airbag and reduce their deployment time, resulting in a rapid response to a vehicle collision. The present invention includes a side curtain airbag, an inflator, and a gas pipe formed with a plurality of gas injection films that become detached or dangle from the gas pipe by the pressure of the gas generated when the inflator inflates. The interior of the gas pipe is filled with gas having a predetermined pressure. The curtain airbag is connected to the gas pipe at the points on the gas pipe where the gas injection films are disposed, and becomes inflated by gas injected from the gas pipe when the gas injection films detach or rupture from the gas pipe.

### BRIEF DESCRIPTION OF THE DRAWINGS

For a better understanding of the nature and objects of the present invention, reference should be made to the following detailed description, read in conjunction with the accompanying drawings, in which:

FIG. 1 illustrates a front view of a side curtain airbag according to an embodiment of the present invention;

FIG. 2 is a detailed front view of a gas pipe according to an embodiment of the present invention;

FIG. 3 is a side sectional view of the gas pipe taken along line A-A of FIG. 2; and

FIG. 4 is a perspective view illustrating the operation of the gas pipe of FIG. 2.

### DETAILED DESCRIPTION OF A PREFERRED EMBODIMENT

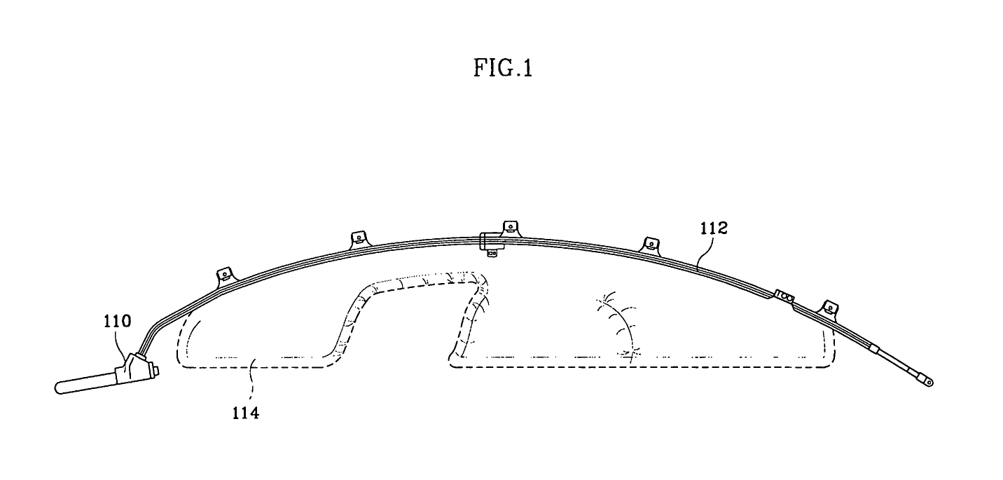

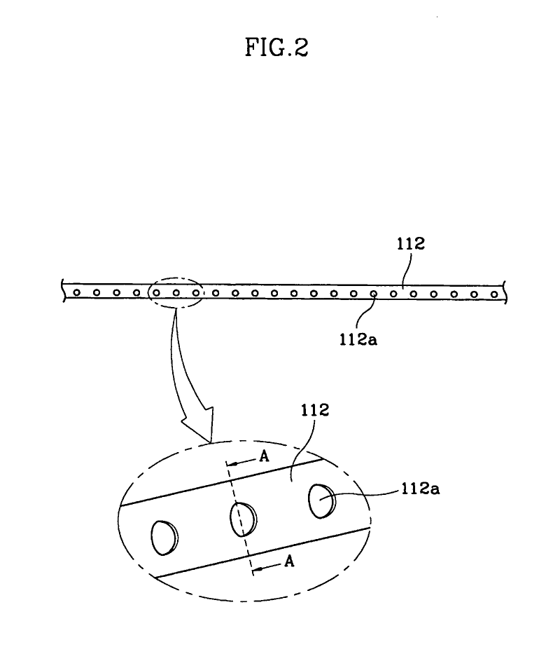

With reference to FIGS. 1 and 2, a side curtain airbag system of a vehicle comprises a gas pipe 112 for providing gas generated from an inflator 110 to a curtain formed with a plurality of gas injection films 112a for supplying gas to curtain airbag 114. Gas injection films 112a are formed where gas pipe 112 connects to curtain airbag 114.

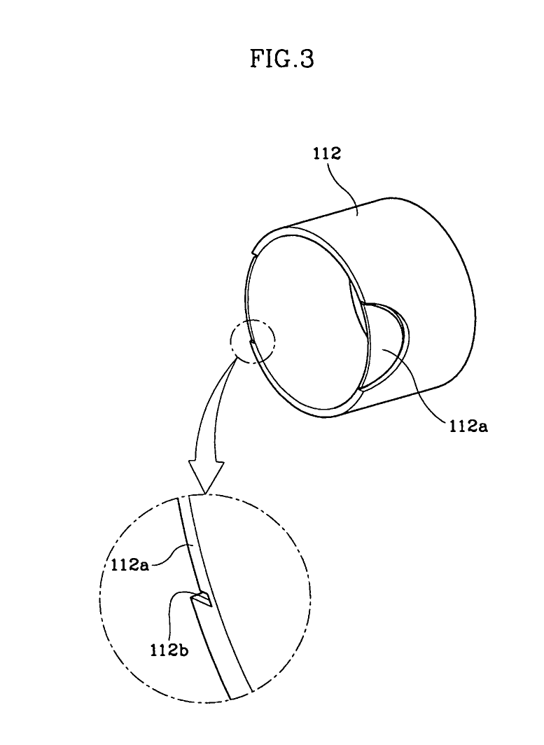

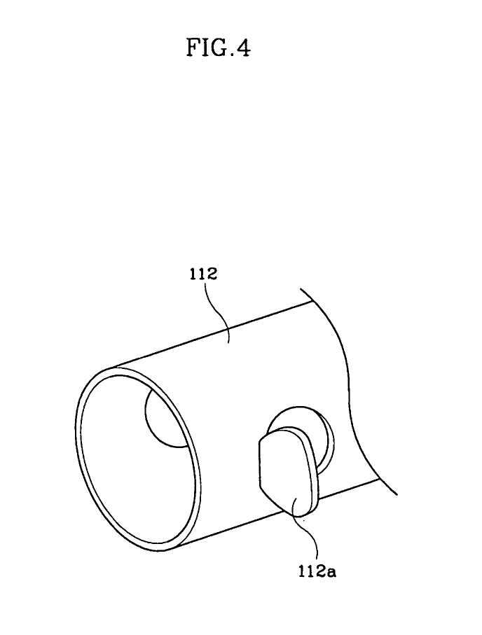

As shown in FIGS. 3 and 4, gas injection film 112a is disposed on gas pipe 112 and may be composed of material identical to that of gas pipe 112. Gas injection film 112a may be formed by a thin film that is relatively thinner than the thickness of gas pipe 112 (i.e., the difference between the thickness of the outer diameter and the inner diameter of gas pipe 112). Gas injection film 112a is circular in the figure, but an elliptical, polygonal, or other shape may be used instead. A groove 112b may be formed on gas pipe 112 at the boundary of gas injection film 112a. Groove 112b is formed to facilitate the detachment or rupture of gas injection film 112a from gas pipe 112 by gas generated when inflator 110 inflates.

Gas injection film 112a may be manufactured in various ways based on the material. The methods include but are not limited to core casting, compressively forging, or punching. For the core casting method, gas injection film 112a and gas pipe 112 are formed simultaneously by using a frame that is pre-manufactured with the shape of gas injection film 112a. In the compressively forging method, the section where gas injection film 112a will be formed is compressed when gas pipe 112 is manufactured. The punching method forms a crack on gas pipe 112 in the shape of gas injection film 112a.

The operation of the side curtain airbag according to the embodiment of the present invention will now be described.

Gas pipe 112 is initially filled with gas under a predetermined pressure such that gas injection films 112a do not detach or rupture. When inflator 110 inflates, additional gas enters gas pipe 112, resulting in a pressure increase in gas pipe 112. Then, as shown in FIG. 4, the pressure increase causes the plurality of gas injection films 112a to detach or dangle from (or become blown off of) gas pipe 112, and gas is injected into curtain airbag 114 instantaneously.

One of ordinary skill in the art will appreciate that a gas pipe is formed with a plurality of gas injection films configured to easily be detached or ruptured by a high pressure blast of gas generated when the inflator inflates. As a result, when the inflator inflates and the high pressure gas is injected into the gas pipe, the plurality of gas injection films are detached or ruptured at the same time by the increased pressure. Thus, the deployment time of the curtain airbag is effectively reduced and the gas is simultaneously delivered to all portions of the curtain airbag. Accordingly, the curtain airbags of a vehicle are able to rapidly inflate, contributing to a prompt response to a vehicle crash.

In one embodiment of the invention, multiple inflators are attached to the gas pipe to inflate each portion of the curtain airbag simultaneously. In another embodiment of the invention, gas injection films 112a are different sizes, with the smallest size being closest to inflator 110, and the a largest size being farthest away from inflator 110. The smaller sized gas injection films 112a and the larger sized gas injection films 112a thus compensate for any difference in inflation time between the portion of curtain airbag closest to inflator 110 and the portion of curtain airbag farthest from inflator 110.

The technical concept of the present invention is not limited to the embodiment of the present invention but may be embodied in various methods in the scope of the present invention. Even though the present invention is described in detail with reference to the foregoing embodiments, it is not intended to limit the scope of the present invention thereto. It is evident from the foregoing that many variations and modifications may be made by a person having an ordinary skill in the present field without departing from the essential concept of the present invention.

1. A side curtain airbag system of a vehicle, the system comprising:
a gas pipe having a wall and filled with a gas at a predetermined pressure;
a plurality of gas injection films disposed in the wall of the gas pipe such that the predetermined pressure of the gas within the gas pipe is lower that that which is needed to detach or rupture any gas injection team;
a curtain airbag connected to said gas pipe where the plurality of gas injection films are disposed on the gas pipe; and
a first inflator connected to the gas pipe;
wherein when the first inflator inflates, gas is injected into the gas pipe, increased pressure in the gas pipe causes at least one of the plurality of gas injection films to detach from the wall of the gas pipe or rupture, and gas inflates the curtain airbag,

2. The air bag system in claim 1, wherein said gas injection film is composed of the same material as the gas pipe.

3. The air bag system in claim 1, wherein said gas injection film has a circular, elliptical, or polygonal shape configuration.

4. The air bag system in claim 2, wherein a groove is formed on the gas pipe at the boundary of at least one of the plurality of gas injection films.

5. The air bag system in claim 1, wherein said gas injection film is thinner than the wall of the gas pipe.

6. The air bag system in claim 1, further comprising:
a second inflator connected to the gas pipe;
wherein when the first inflator inflates, the second inflator inflates and injects gas into the gas pipe, increased pressure in the gas pipe causes at least one of the plurality of gas injection films to detach from the wall of the gas pipe or rupture, and gas inflates the curtain air bag.

7. The air bag system in claim 1, wherein the plurality of gas injection films are of pipe farthest from the inflator.

8. A side curtain airbag system of a vehicle, the system comprising:
a gas pipe with weak points along its wall;
a curtain airbag connected to the gas pipe at the gas pipe's weak points; and
at least one inflator that injects gas into the gas pipe, rupturing the wall of the gas pipe at the weak points such that the injected gas flows into the curtain air bag through the ruptured weak points in the gas pipe's wall.
